(19) United States
(12) Patent Application Publication
(10) Pub. No.: US 2024/0378448 A1
(43) Pub. Date: Nov. 14, 2024

(54) ELECTRONIC DEVICES AND METHODS FOR LEARNING DATA GENERATION AND PRODUCT ANOMALY DETECTION BASED ON UNSUPERVISED LEARNING

(71) Applicant: SK Planet Co., Ltd., Seongnam-si (KR)

(72) Inventor: Yeonghyeon PARK, Suwon-si (KR)

(21) Appl. No.: 18/654,001

(22) Filed: May 3, 2024

(30) Foreign Application Priority Data
May 9, 2023 (KR) 10-2023-0059891
Oct. 18, 2023 (KR) 10-2023-0139717

(51) Int. Cl. G06N 3/09

(52) U.S. Cl. CPC G06N 3/09

(57) ABSTRACT

An electronic device and method are provided for generating abnormal data among learning data required for training a machine learning model. In addition, an electronic device and method are provided for a product anomaly detection using a model trained based on unsupervised learning. Embodiments may solve the data imbalance problem for learning by generating as much abnormal data as necessary based on normal data and provide an unsupervised learning-based anomaly detection method and electronic device that can provide stable performance without increasing the size or complexity of the artificial neural network and thus requiring relatively high-performance computing equipment.

### CROSS-REFERENCE TO RELATED APPLICATIONS

The present application is based upon and claims the benefit of priority to Republic of Korea Patent Application Nos. 10-2023-0059891, filed on May 9, 2023, and 10-2023-0139717, filed on Oct. 18, 2023, which are incorporated by reference herein in their entirety.

### TECHNICAL FIELD

The present disclosure relates to a technology for generating abnormal data among learning data required for training a machine learning model, and also relates to a technology for a product anomaly detection using a model trained based on unsupervised learning.

### BACKGROUND ART

Recently, anomaly detection technology based on artificial intelligence has been applied to real life. In order for artificial intelligence-based anomaly detection to provide appropriate results, learning on various data is required. In anomaly detection (or defect detection) situations, it is generally possible to collect relatively large amounts of normal type data. In contrast, compared to normal type data, abnormal (or defective) type data may be relatively difficult to collect.

Thus, in the process of collecting normal type data and abnormal type data, an imbalance problem of data quantity occurs, and as a result, difficulties arise in training and operating a machine learning model based on artificial intelligence that needs to learn on the collected data. To solve this problem, a method of performing unsupervised learning based on normal type data and determining if there is a problem when abnormal type data is inputted during the testing stage may be operated. However, even if an unsupervised learning method is adopted, an error may be made in misjudging unobserved normal type data as abnormal type data, which causes a problem that unsupervised machine learning model training does not guarantee appropriate results.

Additionally, methods using machine vision and artificial intelligence have been recently used to detect defects in manufactured products. In this process, artificial intelligence learning is necessary, and an appropriate number of normal and defective images must be secured for artificial intelligence learning. In particular, various types and large quantities of defective images may be required to detect the presence or absence of defects in manufactured products. However, in actual product manufacturing sites, the goal is to design the factory line to minimize the occurrence of defective products, so it is difficult to secure images of defective products, and it is also difficult to secure images of various defective products. Therefore, there is a need to develop a detection method capable of providing stable performance in determining whether a product is defective.

### SUMMARY

Accordingly, the present disclosure is intended to provide a learning data generation method and electronic device that can solve the data imbalance problem for learning by generating as much abnormal data as necessary based on normal data.

In addition, the present disclosure is intended to provide an unsupervised learning-based anomaly detection method and electronic device that can provide stable performance without increasing the size or complexity of the artificial neural network and thus requiring relatively high-performance computing equipment.

Also, the present disclosure is intended to minimize the increase in computational load and improve anomaly detection performance while using edge computing equipment, and to support the construction of an automated anomaly detection system in the manufacturing process.

According to an embodiment of the present disclosure, an electronic device may include a memory storing normal data and a processor functionally connected to the memory. The processor may be configured to acquire the normal data from the memory, to select a first specific position of the normal data as an initial position according to setting, select first data being at the initial position, and exchange the first data with second data being at a second specific position corresponding to a movement direction and movement distance value set based on the first specific position, wherein the exchange is repeated a predetermined number of times, and to store data after the exchange between the first data and the second data in the normal data is repeatedly performed the predetermined number of times, in the memory as abnormal data for training a machine learning model.

The normal data may be image data, and the processor may be configured to select at least one pixel data disposed at the first specific position of the image data as the first data of the initial position, and to select one of eight adjacent pixel directions based on the first specific position as the movement direction.

The processor may be configured to select at least one pixel direction among the eight pixel directions according to a user input, and to determine a randomly selected movement direction among the at least one selected pixel direction as the movement direction.

The processor may be configured to select a randomly selected constant value within a certain constant range as the movement distance value, and to determine a position spaced apart from the first specific position by the selected movement distance value as the second specific position.

The processor may be configured to adjust the constant range according to a user input.

The processor may be configured to select a randomly selected constant value within a certain constant range as the movement distance value, and to calculate a new movement distance value every time during the predetermined number of times.

The processor may be configured to define a plurality of pixel data arranged at the first specific position as a kernel, and to perform the exchange on a per kernel basis.

According to an embodiment of the present disclosure, a learning data generation method performed by a processor of an electronic device may include acquiring normal data from a memory; selecting a first specific position of the normal data as an initial position according to setting, selecting first data being at the initial position, and exchanging the first data with second data being at a second specific position corresponding to a movement direction and movement distance value set based on the first specific position, wherein the exchanging is repeated a predetermined number of times; and storing data after the exchanging between the first data and the second data in the normal data is repeatedly performed the predetermined number of times, in the memory as abnormal data for training a machine learning model.

The normal data may be image data, at least one pixel data disposed at the first specific position of the image data may be selected as the first data of the initial position, and one of eight adjacent pixel directions based on the first specific position may be selected as the movement direction.

At least one pixel direction among the eight pixel directions may be selected according to a user input, and a randomly selected movement direction among the at least one selected pixel direction may be determined as the movement direction.

A randomly selected constant value within a certain constant range may be selected as the movement distance value, and a position spaced apart from the first specific position by the selected movement distance value may be selected as the second specific position.

The constant range may be adjusted according to a user input.

A randomly selected constant value within a certain constant range may be selected as the movement distance value, and a new movement distance value may be calculated every time during the predetermined number of times.

A plurality of pixel data arranged at the first specific position may be defined as a kernel, and the exchanging may be performed on a per kernel basis.

According to an embodiment of the present disclosure, an electronic device may include a communication circuit receiving input information about a product, a memory storing the input information, and a processor functionally connected to the communication circuit and the memory. The processor may be configured to, for learning of a reconstruction model for anomaly detection in the product, select salient regions for the input information, to generate input information with salient regions mosaicked by performing a mosaic operation on the selected salient regions, to generate a reconstructed output by applying the input information with salient regions mosaicked to the reconstruction model, and to update the reconstruction model based on a difference value between the input information and the reconstructed output.

The processor may be configured to produce a saliency map by applying a pre-trained model to the input information, and to produce a saliency mask based on the saliency map.

The processor may be configured to select the salient regions of the input information by mosaicking the input information and then performing convolution with the saliency mask, to produce mosaic data by performing a mosaic operation on the selected salient regions, to produce original data for non-salient regions of the input information by applying the inverse value of the salient mask to the input information, and to generate the input information with salient regions mosaicked by merging the mosaic data and the original data.

The processor may be configured to update the reconstruction model so that the difference value between the input information and the reconstructed output is less than a predetermined threshold value, and to complete the learning of the reconstruction model when the difference value is less than the predetermined threshold value.

The processor may be configured to, upon acquiring new input information about a new product, produce new input information with salient regions mosaicked by applying the new input information to a pre-trained model, to produce a new reconstructed output by applying the new input information with salient regions mosaicked to the learning-completed reconstruction model, when a difference value between the new input information and the new reconstructed output is less than a predetermined threshold value, to determine that a product corresponding to the new input information is normal, and when the difference value between the new input information and the new reconstructed output is greater than or equal to a predetermined threshold value, to determine that the product corresponding to the new input information is abnormal.

The difference value may include a distance value between the new input information and the new reconstructed output.

According to an embodiment of the present disclosure, a product anomaly detection method based on unsupervised learning, performed by a processor of an electronic device, may include, for learning of a reconstruction model for anomaly detection in a product, selecting salient regions for an input information; generating input information with salient regions mosaicked by performing a mosaic operation on the selected salient regions; generating a reconstructed output by applying the input information with salient regions mosaicked to the reconstruction model; and updating the reconstruction model based on a difference value between the input information and the reconstructed output.

The method may further include producing a saliency map by applying a pre-trained model to the input information; and producing a saliency mask based on the saliency map.

Selecting the salient regions may include selecting the salient regions of the input information by mosaicking the input information and then performing convolution with the saliency mask. Generating the input information with salient regions mosaicked may include producing mosaic data by performing a mosaic operation on the selected salient regions; producing original data for non-salient regions of the input information by applying the inverse value of the salient mask to the input information; and generating the input information with salient regions mosaicked by merging the mosaic data and the original data.

Updating the reconstruction model may include updating the reconstruction model so that the difference value between the input information and the reconstructed output is less than a predetermined threshold value; and completing the learning of the reconstruction model when the difference value is less than the predetermined threshold value.

The method may further include acquiring new input information about a new product; producing new input information with salient regions mosaicked by applying the new input information to a pre-trained model; producing a new reconstructed output by applying the new input information with salient regions mosaicked to the learning-completed reconstruction model; when a difference value between the new input information and the new reconstructed output is less than a predetermined threshold value, determining that a product corresponding to the new input information is normal; and when the difference value between the new input information and the new reconstructed output is greater than or equal to a predetermined threshold value, determining that the product corresponding to the new input information is abnormal.

The difference value may include a distance value between the new input information and the new reconstructed output.

According to the present disclosure, supervised learning can be performed by balancing the quantity of normal type data and abnormal type data, thereby supporting diversity learning of an anomaly detection model based on unsupervised learning. Therefore, the probability of misjudging new normal type data as abnormal type data can be reduced and the generalization ability of the supervised learning-based anomaly detection model can be strengthened.

Additionally, according to the present disclosure, by generating abnormal type data using normal type data (or data selected from defective type data), it is possible to maintain a natural form and also generate data that does not overlap with existing samples.

According to the present disclosure, it is possible to build an automated system for detecting anomalies and provide stable anomaly detection performance while minimizing the increase in computational load.

### BRIEF DESCRIPTION OF DRAWINGS

FIG. 1 is a diagram illustrating an electronic device for generating learning data according to the first embodiment of the present disclosure.

FIG. 2 is a diagram illustrating a processor of the electronic device according to the first embodiment of the present disclosure.

FIG. 3 is a diagram illustrating random walk processing related to abnormal data generation according to the first embodiment of the present disclosure.

FIG. 4 is a diagram illustrating abnormal data generation according to the first embodiment of the present disclosure.

FIG. 5 is a diagram illustrating one example of a learning data generation method performed by the electronic device according to the first embodiment of the present disclosure.

FIG. 6 is a diagram illustrating another example of a learning data generation method performed by the electronic device according to the first embodiment of the present disclosure.

FIG. 7 is a diagram illustrating an example of a system environment to which a product anomaly detection function according to the second embodiment of the present disclosure is applied.

FIG. 8 is a diagram illustrating a first electronic device according to the second embodiment of the present disclosure.

FIG. 9 is a diagram illustrating a second electronic device according to the second embodiment of the present disclosure.

FIG. 10 is a diagram illustrating a processor of the second electronic device according to the second embodiment of the present disclosure.

FIG. 11 is a diagram illustrating a process related to a learning strategy of an anomaly detection model according to the second embodiment of the present disclosure.

FIG. 12 is a diagram illustrating a method for selecting a saliency region in the learning strategy of the anomaly detection model according to the second embodiment of the present disclosure.

FIG. 13 is a diagram illustrating a method for calculating input information with saliency region mosaicked in the learning strategy of the anomaly detection model according to the second embodiment of the present disclosure.

FIG. 14 is a diagram illustrating a product anomaly detection process according to the second embodiment of the present disclosure.

FIG. 15 is a diagram illustrating a method for learning a product anomaly detection model performed by the second electronic device according to the second embodiment of the present disclosure.

FIG. 16 is a diagram illustrating a method for a product anomaly detection performed by the second electronic device according to the second embodiment of the present disclosure.

FIG. 17 is a diagram illustrating measurement results for anomaly detection performance for the anomaly detection data set MVTec AD.

### DETAILED DESCRIPTION

Now, embodiments of the present disclosure will be described in detail with reference to the accompanying drawings.

However, in the following description and the accompanying drawings, well known techniques may not be described or illustrated in detail to avoid obscuring the subject matter of the present disclosure. Through the drawings, the same or similar reference numerals denote corresponding features consistently.

The terms and words used in the following description, drawings and claims are not limited to the bibliographical meanings thereof and are merely used by the inventor to enable a clear and consistent understanding of the disclosure. Thus, it will be apparent to those skilled in the art that the following description about various embodiments of the present disclosure is provided for illustration purpose only and not for the purpose of limiting the disclosure as defined by the appended claims and their equivalents.

Additionally, the terms including expressions “first”, “second”, etc. are used for merely distinguishing one element from other elements and do not limit the corresponding elements. Also, these ordinal expressions do not intend the sequence and/or importance of the elements.

Further, when it is stated that a certain element is “coupled to” or “connected to” another element, the element may be logically or physically coupled or connected to another element. That is, the element may be directly coupled or connected to another element, or a new element may exist between both elements.

In addition, the terms used herein are only examples for describing a specific embodiment and do not limit various embodiments of the present disclosure. Also, the terms “comprise”, “include”, “have”, and derivatives thereof mean inclusion without limitation. That is, these terms are intended to specify the presence of features, numerals, steps, operations, elements, components, or combinations thereof, which are disclosed herein, and should not be construed to preclude the presence or addition of other features, numerals, steps, operations, elements, components, or combinations thereof.

In addition, the terms such as “unit” and “module” used herein refer to a unit that processes at least one function or operation and may be implemented with hardware, software, or a combination of hardware and software.

In addition, the terms “a”, “an”, “one”, “the”, and similar terms are used herein in the context of describing the present invention (especially in the context of the following claims) may be used as both singular and plural meanings unless the context clearly indicates otherwise

Also, embodiments within the scope of the present invention include computer-readable media having computer-executable instructions or data structures stored on computer-readable media. Such computer-readable media can be any available media that is accessible by a general purpose or special purpose computer system. By way of example, such computer-readable media may include, but not limited to, RAM, ROM, EPROM, CD-ROM or other optical disk storage, magnetic disk storage or other magnetic storage devices, or any other physical storage medium that can be used to store or deliver certain program codes formed of computer-executable instructions, computer-readable instructions or data structures and which can be accessed by a general purpose or special purpose computer system.

### First Embodiment

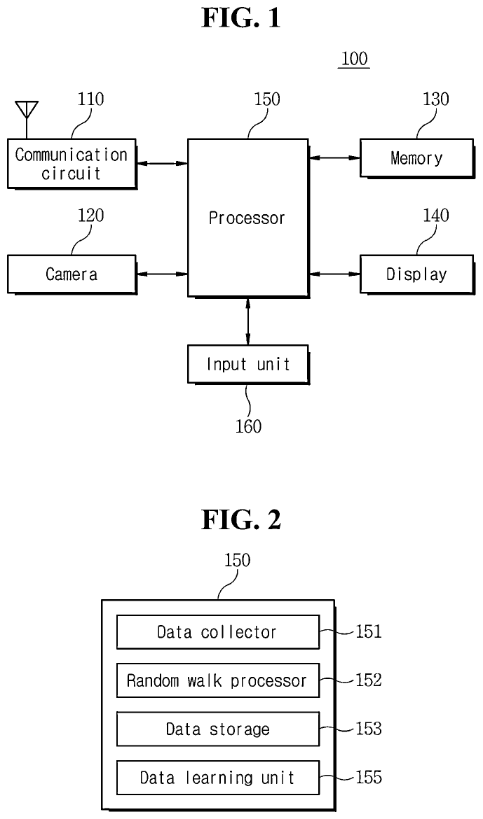

FIG. 1 is a diagram illustrating an electronic device for generating learning data according to the first embodiment of the present disclosure.

Referring to FIG. 1, the electronic device 100 for the generation of learning data may include a communication circuit 110, a camera 120, a memory 130, a display 140, an input unit 160, and a processor 150.

The electronic device 100 can learn an artificial intelligence model and be deployed in various environments capable of providing an anomaly detection function using the learned artificial intelligence model. For example, in the case of desiring to collect data to learn the artificial intelligence model that can determine road conditions or vehicle operation situations, the electronic device 100 may be disposed at a position to observe a designated road or connected to a sensor placed to observe a designated road through communication. Also, in the case of requiring to learn the artificial intelligence model for forest or valley observations, the electronic device 100 may be disposed to acquire image data regarding a designated forest or valley or functionally connected to a sensor placed to acquire image data. The environment in which the electronic device 100 is disposed is not limited to locations related to acquisition of image data. For example, the electronic device 100 may be placed in an environment that can perform learning on audio signals and provide an anomaly detection function based on the performed learning model.

The communication circuit 110 may support a communication function of the electronic device 100. For example, the communication circuit 110 may establish a communication channel with at least one sensor or external electronic device (or a server) to collect normal data. The at least one sensor may include a camera (e.g., an RGB camera or a spectral camera) capable of photographing a target related to generation of an artificial intelligence model. In this case, the communication circuit 110 may establish a wired and/or wireless communication channel with a sensor that collects normal data. In addition, the communication circuit 110 may establish a wireless communication channel with an external electronic device and receive at least one normal data from the external electronic device in response to an input control by the user of the electronic device 100.

The camera 120 may be included when the electronic device 100 is configured to capture images corresponding to normal data. Therefore, when the electronic device 100 is designed to collect normal data through the communication circuit 110 or to receive normal data from the sensor or the external electronic device, the camera 120 may be excluded from the electronic device 100. The camera 120 may include at least one of various camera types depending on the characteristics of image data to be acquired. For example, the camera 120 may include at least one of an infrared camera, a red-green-blue (RGB) camera, and a spectral camera. Correspondingly, the normal data may include at least one of an infrared image, an RGB image, or a spectral image. Upon collecting image data corresponding to normal data in response to a user's manipulation, the camera 120 may transmit the collected image data to the memory 130 in response to the control of the processor 150.

The memory 130 may store data or programs related to the operation of the electronic device 100. For example, the memory 130 may store at least one normal data. For example, the normal data may include at least one of image data captured by the camera 120 or image data received by the communication circuit 110. The memory 130 may store at least one abnormal data generated by applying a random walk function to the normal data. In addition, the memory 130 may include at least one learning algorithm capable of generating a learning model based on at least some of the normal data or the generated abnormal data. For example, the learning algorithm may include a supervised learning algorithm or an unsupervised learning algorithm. The memory 130 may include a learning model generated based on the learning algorithm.

The display 140 may output at least one screen related to the operation of the electronic device 100. For example, the display 140 may output a screen related to the collection of normal data. In an example, the display 140 may display a screen related to the operation of the camera 120 and a screen including an image (e.g., normal data) captured under normal conditions. When a random walk function is applied to normal data, the display 140 may output a screen that displays a process of designating at least one pixel data and then applying a random walk process to the at least one designated pixel data a specified number of times and at least one of abnormal data generated as the result of applying the random walk process.

The display 140 may output at least one of a screen of searching for normal data and abnormal data stored in the memory 130 and a screen of outputting at least one learning model list generated based on normal data and abnormal data. In addition, the display 140 may output a list of normal data and abnormal data items stored in the memory 130, and when a specific item is selected, the display 140 may output an image of the selected item (e.g., normal data or abnormal data). In addition, the display 140 may output, in response to selection of certain normal data, a list of abnormal data generated through the selected normal data, and also output, in response to selection of certain abnormal data, normal data (e.g., normal data before the random walk process is applied) corresponding to the selected abnormal data. Also, when certain abnormal data is selected, the display 140 may display normal data corresponding to the selected abnormal data and explanatory information about the random walk process applied to the normal data upon generating the abnormal data.

The input unit 160 may support an input function of the electronic device 100. For example, the input unit 160 may include at least one of a keyboard, a keypad, a touch screen, a touch pad, a joystick, a mouse, a wheel, a voice input device, and a gesture input device. The input unit 160 may create, in response to a user's input, an input signal for controlling the turn-on or turn-off of the electronic device 100, an input signal related to retrieving information stored in the memory 130, an input signal related to controlling the operation of the camera 120, an input signal for controlling at least one screen outputted on the display 140, etc., and then transmit the created input signal to the processor 150. For example, in response to a user's manipulation, the input unit 160 may create an input signal for selecting specific normal data, an input signal for requesting the generation of a certain number of abnormal data based on the selected normal data, an input signal for requesting the memory 130 to store the at least one generated abnormal data, and the like.

The processor 150 may control transmitting and processing signals related to the operation of the electronic device 100 and also control storing or transmitting the processing results. For example, the processor 150 may control collecting normal data to be used to generate abnormal data by applying a random walk. The processor 150 may select a random walk process to be applied, according to the characteristics of the collected normal data or a user's input, and generate at least one abnormal data in accordance with the selected random walk process. The processor 150 may store the generated abnormal data in the memory 130, and if the number of abnormal data (or normal data and abnormal data) is more than a predefined certain quantity, the processor 150 may perform machine learning model training based on at least some of the stored normal data and abnormal data. In this regard, the processor 150 may include components as shown in FIG. 2.

FIG. 2 is a diagram illustrating a processor of the electronic device according to the first embodiment of the present disclosure.

Referring to FIG. 2, the processor 150 may include a data collector 151, a random walk processor 152, a data storage 153, and a data learning unit 154.

The data collector 151 may control the collection of normal data to be used for generating abnormal data. In an example, the data collector 151 may activate the camera 120 according to a pre-designated condition or environment and acquire an image for a designated direction or subject using the activated camera 120. Here, the designated condition or environment may be a condition or environment for obtaining normal data. The electronic device 100 may include at least one sensor capable of sensing the surrounding situation to determine whether the designated condition or environment is met, or collect information about the surrounding environment through the communication circuit 110 and check the collected information to determine whether the designated condition or environment is met. In addition, the data collector 151 may activate the communication circuit 110 according to a user's input or predetermined scheduling information, establish a communication channel with an external electronic device such as a server, and receive at least one normal data from the external electronic device. The normal data may include, for example, image data corresponding to the type or characteristics of a learning model to be generated. The data collector 151 may temporarily or semi-permanently store the collected normal data in the memory 130.

The random walk processor 152 may apply at least one random walk process to the normal data collected by the data collector 151 to generate at least one abnormal data. In this process, the random walk processor 152 may assign a first identification number to normal data and a second identification number to at least one abnormal data generated from the normal data, where the second identification number may be related to (or linked to) the first identification number. For example, the first and second identification numbers may have, at least in part, the same numbers or letters. Additionally, the first identification number may have letters or numbers indicating normal data, and the second identification number may have letters or numbers indicating abnormal data. In another example, assigning the first identification number to normal data may be performed by the data collector 151, and assigning the second identification number to abnormal data may be performed by the random walk processor 152. For example, in relation to applying the random walk process, the random walk processor 152 may specify the position of at least one pixel in image data corresponding to normal data and exchange the positions of at least one pixel at the specified position and at least one surrounding pixel a predefined number of times to generate at least one abnormal data.

The random walk processor 152 may set at least one of a scheme of selecting the initial position (e.g., a position where at least one pixel for starting the random walk process is disposed), the number or shape of pixels to which the random walk process is to be applied, the direction of the surrounding pixels to be exchanged through the random walk process based on the initial position (or the direction in which pixel data of the initial position will be moved), and the distance to the pixel to be exchanged based on the initial position (or the distance to which pixel data of the initial position will be moved), differently depending on specified conditions (e.g., at least one of the type of a learning model to be generated, the number of abnormal data to be generated from one normal data, the total number of abnormal data to be generated for learning, the size or resolution of normal data, the image characteristics (e.g., screen complexity) of normal data). Additionally, the random walk processor 152 may define as a kernel at least one pixel group to which the random walk process is to be applied, and define at least one of the shape of the kernel, the size of the kernel, the start point of the kernel, the moving direction (or replacement direction) of the kernel, the distance the kernel moves at one time, and the number of times the kernel moves, differently depending on specified conditions.

In an example, as the resolution of normal data or the size of image is larger (or smaller) than a threshold value, the random walk processor 152 may set at least one of the size of the kernel, the distance the kernel moves at one time, and the number of times to apply the random walk to be larger (or smaller) (e.g., set it to be larger compared to the case where the resolution of normal data or the size of image is smaller than the threshold value). Alternatively or additionally, as the number of abnormal data to be generated by settings or a user input is greater (or less) than a threshold value, the random walk processor 152 may set at least one of the size of the kernel, the distance the kernel moves at one time, and the number of times to apply the random walk to be more (or less) than the threshold value.

The data storage 153 may store normal data collected by the data collector 151 and at least one abnormal data generated by the random walk processor 152. In this process, the data storage 153 may link (or associate with) normal data and at least one abnormal data generated from normal data. Additionally, the data storage 153 may add tag information to at least one generated abnormal data. The tag information may include the identification number of normal data used to generate abnormal data, the random walk process applied to generate abnormal data (e.g., the shape of the kernel, the size of the kernel, the start point of the kernel, the moving direction (or replacement direction) of the kernel, the distance the kernel moves at one time, and the number of times the kernel moves), the generation time of abnormal data, and the identification number of abnormal data. The data storage 153 may provide normal data and abnormal data by sorting them in at least one of the storage period or the image data size according to a user's request. Additionally or alternatively, when the number of at least one of normal data and abnormal data is greater than or equal to a predetermined number, the data storage 153 may transmit the corresponding event to the data learning unit 154.

When the number of at least one of normal data and abnormal data from the data storage 153 is greater than or equal to a predetermined number, the data learning unit 154 may acquire at least one of the normal data and abnormal data stored in the data storage 153 and perform learning based on at least one of the acquired normal data and abnormal data, thereby generating a model. In an example, the data learning unit 154 may independently perform unsupervised learning on each of normal data or abnormal data to generate an unsupervised learning model for normal data or an unsupervised learning model for abnormal data. Alternatively, the data learning unit 154 may generate a supervised learning model using normal data and abnormal data.

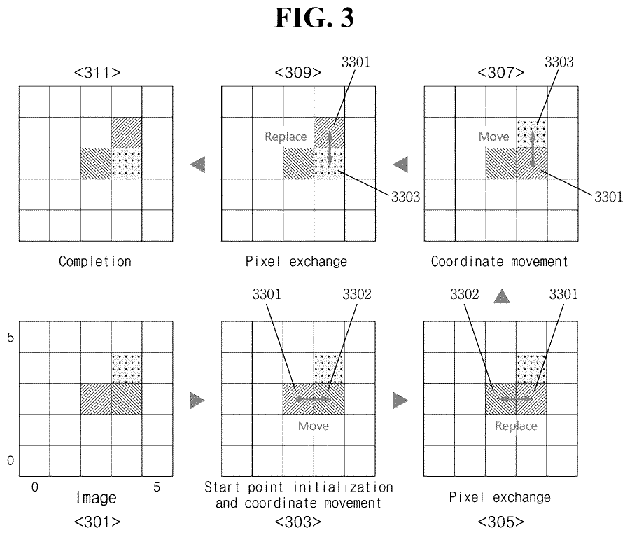

FIG. 3 is a diagram illustrating random walk processing related to abnormal data generation according to the first embodiment of the present disclosure.

Referring to FIG. 3, the processor 150 (or the random walk processor 152) may acquire an image corresponding to normal data as in state 301. For example, the processor 150 may activate the camera 120 and acquire an image corresponding to normal data through the activated camera, acquire an image corresponding to normal data from an external electronic device such as a server through the communication circuit 110, or acquire an image corresponding to normal data previously stored in the memory 130. In the drawing, a total of 25 pixels are arranged, 5 horizontally and 5 vertically, but the present disclosure is not limited to this example. The number of horizontal and vertical pixels in an image, i.e., the resolution of the image (a resolution of H×W, where each of H and W is a natural number) can vary. In addition, the number of times the random walk process is applied can be adjusted according to a user's selection. The random walk process may refer to, for example, exchanging a pixel disposed at the initial position, e.g., (3, 3) coordinates, with another adjacent pixel.

As in state 303, the processor 150 may randomly initialize the initial position (or start point) of the random walk process and coordinately move the first pixel data 3301 (or pixel value or pixel color data) at the initial position to a target position along a movement direction determined according to a certain condition (e.g., random method). For example, the processor 150 may set the (3, 3) position as the initial position. In this process, the initial position (3, 3) may be one of randomly selected positions or a pixel position corresponding to the center point or center area of normal data. The processor 150 may coordinately move the first pixel data 3301 disposed at the initial position (3, 3) to another adjacent position, such as (4, 3). Here, the second pixel data 3302 may be in a state of being disposed at the (4, 3) position.

The processor 150 may perform pixel exchange of the first pixel data 3301 and the second pixel data 3302 as in state 305. For example, the processor 150 may perform pixel exchange by moving the first pixel data 3301 to the (4, 3) pixel position and simultaneously moving the second pixel data 3302 to the (3, 3) position. The processor 150 may check the predetermined number of pixel movements, and when the number of pixel movements remains, the processor 150 may move the first pixel data 3301 to another pixel position, such as the (4, 4) pixel position, as in state 307. Here, the movement direction of the first pixel data 3301 may be one randomly determined direction among eight directions toward surrounding pixels. The processor 150 may perform pixel exchange, as in state 309, by moving the first pixel data 3301 to the (4, 4) pixel position and simultaneously moving the third pixel data 3303 of the (4, 4) pixel position to the (4, 3) pixel position.

The processor 150 may check whether the number of processing times for pixel exchange reaches the predetermined number of pixel movements. When the number of pixel movements is reached, the processor 150 may complete processing as in state 311 and store abnormal data generated upon completion in the memory 130.

Although the pixel exchange method for generating abnormal data by replacing one pixel data with another adjacent pixel data has been described above, the present disclosure is not limited to this. In an alternative pixel exchange method, the processor 150 may select a plurality of pixel data (e.g., the first to third pixel data 3301, 3302, and 3303) as a kernel and replace the selected pixel data with a plurality of pixel data (or another kernel) at other adjacent pixel positions. In this process, the number and/or form of pixel data included in the kernel may be adjusted or set according to a user input or randomly. If there is no separate user input after specifying the kernel, the processor 150 may set the size and shape of the kernel according to default values set in the system. In the default settings of the random walk process, the selected pixel data can be set to move to a point where the Euclidean distance is 1.

In one example, the movement distance may increase or decrease according to a user's setting or change through a random setting. In the case of the random setting, the processor 150 may sample random values between constants A and B (B is a natural number greater than A), and the movement distance per number of times may be the same or different depending on the sampled values. Alternatively, in the case of the random setting, based on the current location, the processor 150 may set random adjacent pixels within the movement direction or movement range (e.g., a range including at least one pixel among eight adjacent pixels based on the current location) according to a user's input. Alternatively, the processor 150 may apply the random direction and random distance simultaneously, separately, or alternately. For example, if there is no setting for the movement range or direction based on the current location, the processor 150 may move pixel data (or kernel) at the current location by a random distance (e.g., a randomly selected movement distance of 1 or more (or 1 or more pixels)) (or replace it with pixel data at the corresponding position) while moving in a specific angle range (or in a randomly selected direction within the theta range set by the user if there is a user's setting) out of 360 degrees (or 8 pixel directions).

In the process of exchanging a specified kernel at a specific pixel position (or pixel positions) with another adjacent kernel, if an overlapping area occurs because the movement distance is smaller than the size of the two kernels, the processor 150 may apply overwriting to the overlapping area or select one of the average and maximum values of the two exchanged kernels. Additionally or alternatively, the processor 150 may increase the initially selected pixel data while performing position replacement in multiple directions during the pixel data replacement process. For example, in order to move the first pixel data 3301 to a plurality of pixel positions, the processor 150 may copy the first pixel data 3301 multiple times and move the first pixel data 3301 to a plurality of adjacent pixel positions (e.g., (4, 3) and (2, 2) pixel positions). In this process, any one of the pixel data at the (4, 3) and (2, 2) pixel positions may be moved to the (3, 3) pixel position of the first pixel data 3301 according to specified conditions (e.g., a condition that pixel data with a relatively large (or small) color data value is selected). Meanwhile, in the above description, normal data is described as image data, but the description may be applied equally or similarly to one-dimensional electronic signals such as audio.

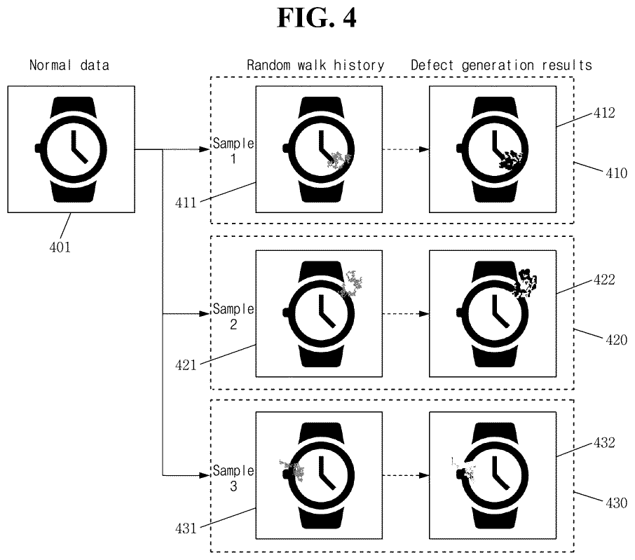

FIG. 4 is a diagram illustrating abnormal data generation according to the first embodiment of the present disclosure.

Referring to FIG. 4, the processor 150 of the electronic device 100 may generate three abnormal data 412, 422 and 432 (or defective images) by independently performing three samplings 410, 420 and 430 on one normal data 401 (or normal image). The present disclosure is, however, not limited to this example. Alternatively, the processor 150 may generate two abnormal data from one normal data 401 or may generate four or more abnormal data from one normal data 401.

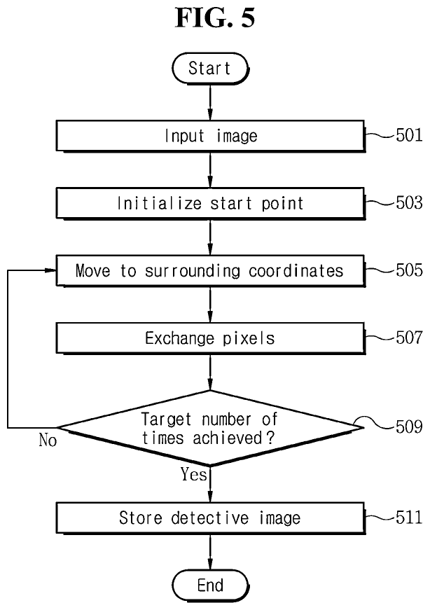

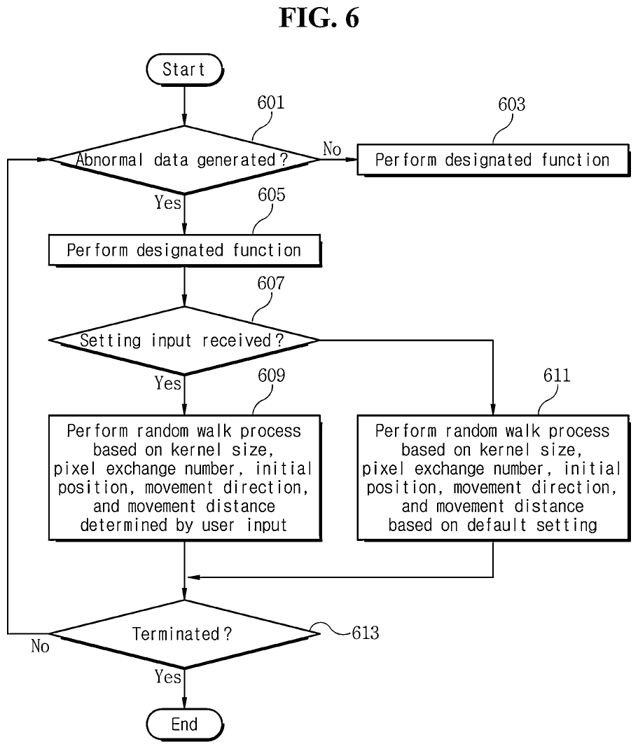

According to defect generation based on the random walk process in the abnormal data generation method described above in FIGS. 1 to 3 or to be described later in FIGS. 5 and 6, the processor 150 may generate abnormal data 412, 422 and 432 by independently performing three samplings 410, 420 and 430 on one normal data 401, and may support the user to check the generated abnormal data 412, 422 and 432 through the display 140. The user can generate as many abnormal data as desired from one normal data 401. Additionally, the processor 150 may not only output the abnormal data 412, 422 and 432 with defect generation completed to the display 140, but also display their histories (e.g., random walk histories 411, 421 and 431) independently or together with the abnormal data 412, 422 and 432. The processor 150 may output at least some of the random walk histories 411, 421 and 431 to the display 140 in response to a user's input.

The random walk histories 411, 421 and 431 represent, in the form of image or video, movement traces in which pixel data (or a kernel composed of at least one pixel data) performed an exchange operation from the start point (or initial position) to the completion of abnormal data generation. The processor 150 may sequentially display coordinate values corresponding to the movement traces of pixel data (or kernel) in response to a user's input (or request).

The above-described random walk process applied to the abnormal data 412, 422 and 432 may include, for example, a state in which the movement direction, the movement distance, and the size and shape of the kernel are not limited and are selected randomly or in response to a user's input.

In relation to performing the above-described operation, the processor 150 of the electronic device 100 may acquire the normal data 401 from the memory 130, select the first specific position of the normal data 401 as the start point (or initial position) according to settings, select the first data (or at least one first pixel data if the normal data is image data) at the start point, perform an exchange operation to exchange the selected first data with the second data (or at least one second pixel data) at the second specific position corresponding to the movement direction and movement distance value set based on the first specific position, and repeatedly perform the exchange operation a predetermined number of times.

The set movement direction may be randomly determined, and if the normal data 401 is image data, any one of eight pixel directions surrounding the initial position (or current pixel position) may be randomly selected. When the pixel direction is limited to at least two of eight pixel directions by a user's input, one pixel direction of the limited at least two pixel directions may be randomly selected. Although the above description focuses a case in which one of eight pixel directions is selected, the present disclosure is not limited to this. Based on the current location, any one angular direction of 360 degrees may be selected as the movement direction, and the user can limit a certain angular range for the 360 degree direction to the range of the movement direction.

The set movement distance may be a random movement distance (e.g., randomly selected from a certain constant range) or a movement distance selected by a user's input (e.g., the user may set a certain constant range). The set movement distance may be fixed by an initial setting value or may be newly set each time the number of times is repeated.

FIG. 5 is a diagram illustrating one example of a learning data generation method performed by the electronic device according to the first embodiment of the present disclosure.

Referring to FIG. 5, in connection with the generating of learning data, the processor 150 of the electronic device 100 may process an image input in step 501. For example, the image may include image data corresponding to the normal data described above. In order to process the image input, the processor 150 may collect image data using the camera 120 under predefined normal conditions (or environments), or establish a communication channel with an external electronic device such as a server for providing normal data through the communication circuit 110 and receive the normal data from the external electronic device. Alternatively, the processor 150 may obtain normal data pre-stored in the memory 130.

In step 503, the processor 150 of the electronic device 100 may initialize the start point (or initial position) according to settings. For example, in relation to initializing the start point, the processor 150 may check the overall size of the input image and set the center point of the image as the start point. Alternatively, the processor 150 may set a specific point within a certain range from the center point of the input image as the start point. Alternatively, the processor 150 may select an inner range within a certain distance from the edge of the image and randomly set a specific point within the selected range as the start point.

When the initial position is set through the start point initialization, in step 505, the processor 150 may move at least one pixel data disposed at the initial position (or a kernel grouped into at least one pixel data wherein the kernel may be composed of only one pixel data or a plurality of pixel data) to surrounding coordinates. In this process, the processor 150 may determine at least one of a random direction and a random distance, and move at least one pixel data at the initial position based on the determined movement direction and movement distance. The random direction may be at least one direction among eight pixel directions surrounding the initial position. The random distance may be a value randomly selected based on the initial position and may change during the number of iterations.

While moving the at least one pixel data (or kernel) in the determined movement direction and movement distance, the processor 150 may perform pixel exchange in step 507 by also moving at least one pixel data (or kernel), placed in the determined movement direction and movement distance, to the initial position.

Next, in step 509, the processor 150 may check whether the target number of times set by the system is achieved. If the target number of times is not achieved, the process may return to step 505. For example, the processor 150 may reset the movement direction and movement distance (or reapplying the previous movement direction and movement distance) based on the pixel position of the previous movement direction and movement distance and then re-perform the movement and exchange of at least one pixel data.

On the other hand, if the target number of times is reached in step 509, the processor 150 may store an image in which pixel exchange of at least one pixel data has been completed, as a defective image (or abnormal data) in the memory 130 in step 511. In this process, the processor 150 may link the defective image to the previous input image, or respectively assign an identification number of the input image and an identification number of the defective image and then manage them as related images through a separate table.

FIG. 6 is a diagram illustrating another example of a learning data generation method performed by the electronic device according to the first embodiment of the present disclosure.

Referring to FIG. 6, in relation to the operation of an electronic device related to the generation of learning data, the processor 150 of the electronic device 100 may check in step 601 whether an event requesting the generation of abnormal data occurs. In this regard, the processor 150 may check whether a user input requesting the generation of abnormal data occurs. Alternatively, the processor 150 may check whether a certain number of normal data or more are collected in connection with the generation of a learning model. If there is no event requesting the abnormal data generation, the processor 150 may perform a designated function in step 603. For example, the processor 150 may collect normal data according to settings. Alternatively, the processor 150 may support search for data stored in the memory 130 in response to a user input.

When an event requesting the generation of abnormal data occurs, the processor 150 may output a screen on the display 140 for selecting an abnormal data generation method in step 605. The generation method selection screen may contain a screen interface that allows at least one of, for example, the size of the kernel, the number of pixel exchanges, the initial position, the movement direction, and the movement distance to be set.

In step 607, the processor 150 may check whether a setting input is received. That is, the processor 150 may check whether a user input of changing at least one of the size of the kernel, the number of pixel exchanges, the initial position, the movement direction, and the movement distance occurs.

When a setting input is received, the processor 150 may perform in step 609 a random walk process based on the size of the kernel, the number of pixel exchanges, the initial position, the movement direction, and the movement distance determined by the user input. Here, the size of the kernel, the number of pixel exchanges, the initial position, the movement direction, and the movement distance may be set as a range. For example, the initial position may be selected as a range larger than one pixel range, the movement direction may be selected as a range of two or more pixel directions out of eight pixel directions, and the movement distance may be selected as a range that does not deviate from the edge of the image from the initial position. The movement distance may be adjusted depending on kernel size settings. For example, the movement distance value when the kernel is set as two pixels may be half of the movement distance value when the kernel is set as one pixel. As described above, in the case where the size of the kernel, the number of pixel exchanges, the initial position, the movement direction, and the movement distance are set as a certain range in response to a user input, the processor 150 may perform a random walk process (i.e., the operation of randomly performing pixel exchange described above in FIG. 5 on at least one pixel data or kernel) for the size of the kernel, the number of pixel exchanges, the initial position, the movement direction, and the movement distance within the range.

If the generation of abnormal data is requested without the reception of a setting input, the processor 150 may perform in step 611 a random walk process based on the size of the kernel, the number of pixel exchanges, the initial position, the movement direction, and the movement distance within a range permitted by the system. For example, the processor 150 may select a randomly selected specific point in the entire normal data as the initial position and perform pixel exchange a randomly selected number of times while moving at least one pixel data by a randomly selected movement distance in a randomly selected direction among eight pixel directions based on the initial position. If applying the kernel is a default mode, the processor 150 may process pixel exchange by applying the initial position, movement direction, and movement distance to a kernel composed of at least one randomly selected pixel data. The processor 150 may maintain the initially set movement direction and movement distance values for the number of pixel exchanges, or may newly calculate at least one of the movement direction and movement distance every time a pixel is exchanged. The number of times may be maintained after the initial calculation until abnormal data generation is complete.

In step 613, the processor 150 may check whether the process terminates upon completion of abnormal data. When additional abnormal data generation is requested, or when N abnormal data generation is set for one normal data in advance, the processor 150 may check whether the current abnormal data generation is the Nth. If the current generation is less than Nth, the processor 150 may return to step 601 to re-perform the subsequent operations. In the case of the Nth generation, the processor 150 may end the abnormal data generation operation. The N value may be preset by the system or adjusted by a user input.

### Second Embodiment

Hereinafter, the system environment to which the product anomaly detection technology of the present disclosure can be applied will be described together with the types and roles of its components.

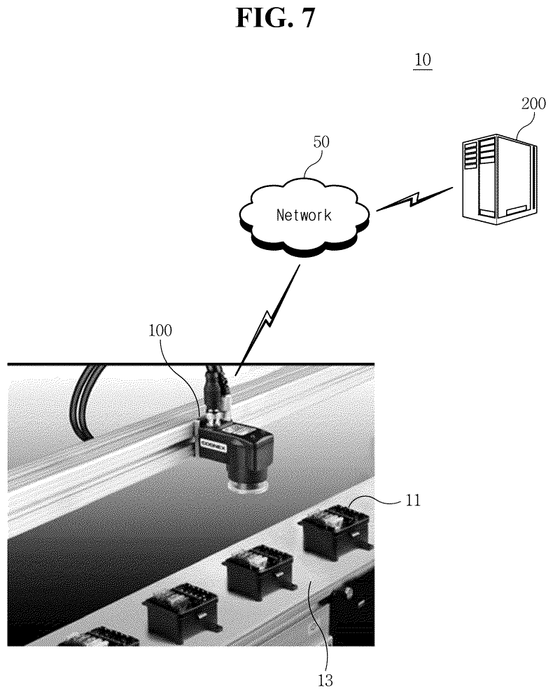

FIG. 7 is a diagram illustrating an example of a system environment to which a product anomaly detection function according to the second embodiment of the present disclosure is applied.

Referring to FIG. 7, the system environment 10 that supports the product anomaly detection function may include at least one product 11, a product holder 13 on which the product 11 is mounted, a communication network 50, a first electronic device 1100 (or an information collecting device) capable of acquiring and managing input information on the product 10, and a second electronic device 1200 (or a server or an information processing device).

The at least one product 11 may include at least one of various products that can be mounted on the product holder 13. For example, the product 11, which can be mounted on the product holder 13, may include various types of structures or items used in real life (e.g., containers, glass bottles, etc.) or electronic devices such as screen display devices or audio output devices. The at least one product 11 may include a product having information that can be collected by the first electronic device 1100. For example, if the first electronic device 1100 is a device that acquires an image as input information, the product 11 may be a product with a standardized or fixed shape that can be captured by a camera. In another example, if the first electronic device 1100 is a device that acquires audio as input information, the product 11 may include a product (e.g., a product including a speaker) that generates audio collected by an audio device.

The product holder 13 may include at least one space where the product 11 can be held (or stored). The product holder 13 may be constructed fixedly or mobile at a designated location. The product holder 13 may be constructed in a form that can hold or store a plurality of products 11. In this case, the product holder 13 may be provided with partitions so that the products 11 can be stored separately by type, size, and shape, or may be isolated from neighboring spaces. The appearance or construction material of the product holder 13 may vary. The product holder 13 can mount at least one product 11 in a specific form through which the first electronic device 1100 can collect input information about the product 11.

The first electronic device 1100 may collect information about the at least one product 11. For example, the first electronic device 1100 may be disposed to acquire an image of the at least one product 11. For example, the first electronic device 1100 may collect at least one image of the at least one product 11 using at least one camera disposed at a place of the product holder 13 where the at least one product 11 is placed. The camera may be disposed to photograph the product 11 mounted on a place (e.g., a shelf) of the product holder 13. The first electronic device 1100 may activate the disposed camera according to predefined schedule information or a designated command (e.g., a command provided by the second electronic device 1200), and acquire an image about the product 11 using the activated camera. Additionally or alternatively, the first electronic device 1100 may collect audio information related to the product 11. In an example, the first electronic device 1100 may collect data for unsupervised learning (e.g., normal data) while performing training on an artificial neural network model used for anomaly detection. The normal data may be provided, for example, by a specific server. Alternatively, the first electronic device 1100 may collect data statistically or empirically at a specific time or period when normal type data are collected, and use the collected data as normal data. The first electronic device 1100 may provide the normal data to the second electronic device 1200 during the model training. For detecting the anomaly in the product 11, the first electronic device 1100 may collect information about the product 11 and provide the collected information as input information to the second electronic device 1200.

The second electronic device 1200 may establish a communication channel with the first electronic device 1100. The second electronic device 1200 may receive information (e.g., at least one of an image taken from the product 11 and audio information output by the product 11) related to the product 11 from the first electronic device 1100, determine whether there are anomalies in the product 11 based on the received information, and output the determination result. Here, the second electronic device 1200 is a component that receives information related to the product 11 from the first electronic device 1100 and analyzes the received information. If the first electronic device 1100 is designed to perform directly anomaly detection related to the product 11, the second electronic device 1200 may be omitted. The second electronic device 200 may generate an artificial intelligence model for a normal type from normal data through unsupervised learning, and detect anomalies regarding the current product 11 using the generated artificial intelligence model. Specifically, the second electronic device 1200 may select saliency regions (or characterized regions) for information about the product 11, perform mosaic processing on the selected saliency regions, and perform a reconstruction process. Then, based on a difference between reconstruction output and input, the second electronic device 1200 may determine whether there are anomalies in the product 11.

The communication network 50 may include at least one communication element capable of connecting the first electronic device 1100 and the second electronic device 1200. For example, the communication network 50 may include a wired cable connecting the first electronic device 1100 and the second electronic device 1200. Alternatively, the communication network 50 may include a wireless network element for transmitting and receiving information between the first electronic device 1100 and the second electronic device 1200. For example, the communication network 50 may include a short-range wireless communication module or may include a long-range wireless communication element including a base station and a base station controller. As such, the communication network 50 is a component for transmitting and receiving data between the first electronic device 1100 and the second electronic device 1200 and is not limited to a specific type, shape, or arrangement.

As described above, in the system environment 10 that supports the anomaly detection function according to the second embodiment of the present disclosure, the first electronic device 1100 configured to collect information related to the product 11 is disposed near the product holder 13 where the product 11 is mounted or stored. The first electronic device 1100 can collect information related to the product 11, and the second electronic device 1200 can acquire the collected information and, based on the acquired information, determine whether there is an anomaly in the product 11. In this process, the second electronic device 1200 can select saliency regions for information about the product 11, perform mosaic processing on the selected saliency regions, and perform a reconstruction process. Then, based on a difference between reconstruction output and input, the second electronic device 1200 may determine whether there are anomalies in the product 11. Therefore, it is possible to detect anomalies in the product 11 through a relatively small computational load while providing more accurate anomaly detection results.

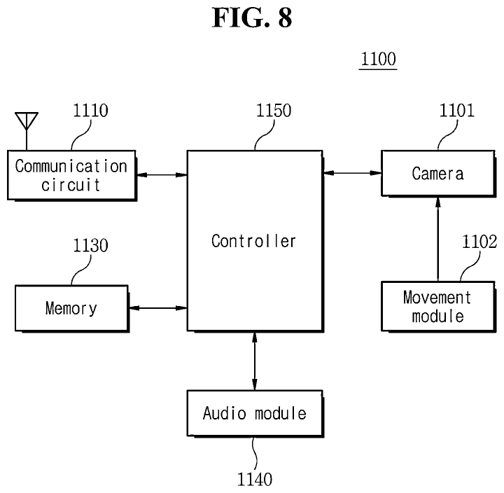

FIG. 8 is a diagram illustrating a first electronic device according to the second embodiment of the present disclosure.

Referring to FIG. 8, the first electronic device 1100 may include a communication circuit 1110, a camera 1101, a movement module 1102, a memory 1130, an audio module 1140, and a controller 1150 (or processor). Additionally, the first electronic device 1100 may further include a power supplier (e.g., a permanent power source or a battery) required for the operation of at least one of the above-mentioned components, that is, the communication circuit 1110, the camera 1101, the movement module 1102, the memory 1130, the audio module 1140, and the controller 1150.

The communication circuit 1110 may establish a communication channel with the second electronic device 1200. When the second electronic device 1200 is designed to perform operations required for the product anomaly detection function according to this embodiment, the communication circuit 1110 may transmit information collected by at least one of the camera 1101 and the audio module 1140 (e.g., images collected by the camera 1101 or audio information collected by the audio module 1140) to the second electronic device 1200. Alternatively, the product anomaly detection function may be independently performed by the first electronic device 1100. In this case, the communication circuit 1110 may directly transmit an administrator notification message or user notification message generated during the operation of the product anomaly detection function to an administrator's or user's terminal device. Additionally, the communication circuit 1110 may transmit a notification message to the second electronic device 1200 in response to control of the controller 1150.

The camera 1101 may be disposed to capture images of at least one product 11. Alternatively, a plurality of cameras 1101 may be disposed in a plurality of areas of the product holder 13 to capture images of the product 11 located within the product holder 13. For example, when the product 11 is placed at a certain point of the product holder 13, the camera 1101 may move to that point and then collect images of the product 11 under the control of the controller 150.

The movement module 1102 may support the movement of the camera 1101 (or the movement of the audio module 1140). For example, the movement module 1102 may include a mounting structure on which the camera 1101 is mounted, a moving member capable of moving the mounting structure in at least one direction, and a power member capable of generating power for moving the moving member. The movement module 1102 is an optional component for moving the camera 1101 or the audio module 140, and if the movement of the camera 1101 or the audio module 1140 is unnecessary, for example, when the camera 1101 or the audio module 1140 is provided as a fixed type, the movement module 1102 may be omitted. In another example, when the camera 1101 and the audio module 1140 are fixed and the product holder 13 is movable, the movement module 1102 may be placed on the product holder 13.

The memory 1130 may store at least one program or data necessary for the operation of the first electronic device 1100. For example, the memory 1130 may store a control program required for the operation of the camera 1101 and images acquired through the camera 1101. Also, the memory 1130 may store images taken while the product 11 is mounted on the product holder 13 or audio information generated from the product 11.

The audio module 1140 may include a microphone capable of collecting audio information generated from the product 11. After being activated under the control of the controller 1150, the audio module 1140 may acquire audio information generated from the product 11 and store the acquired audio information in the memory 1130. In this regard, the audio module 1140 may include a directional or super-directional microphone to acquire audio information generated from one of the plurality of products 11.

The controller 1150 may perform at least one of transmitting and processing signals necessary for the operation of the first electronic device 1100, storing the processing results, and outputting the processing results. For example, the controller 1150 may control the acquisition of images related to the product 11 using the camera 1101 in response to at least one of a predefined event, a notification from the product holder 13 (e.g., information notifying a situation in which the new product 11 is mounted), and a request of the second electronic device 1200. The controller 1150 may provide at least one acquired image to the second electronic device 1200. Also, if the product 11 is a device that outputs audio, the controller 1150 may collect audio information about the product 11 and provide the collected audio information to the second electronic device 1200. In this regard, the controller 1150 may receive a command to activate at least one of the camera 1101 or the audio module 1140 from the second electronic device 1200, activate the camera 1101 and/or the audio module 1140 in response to the received command, and collect information.

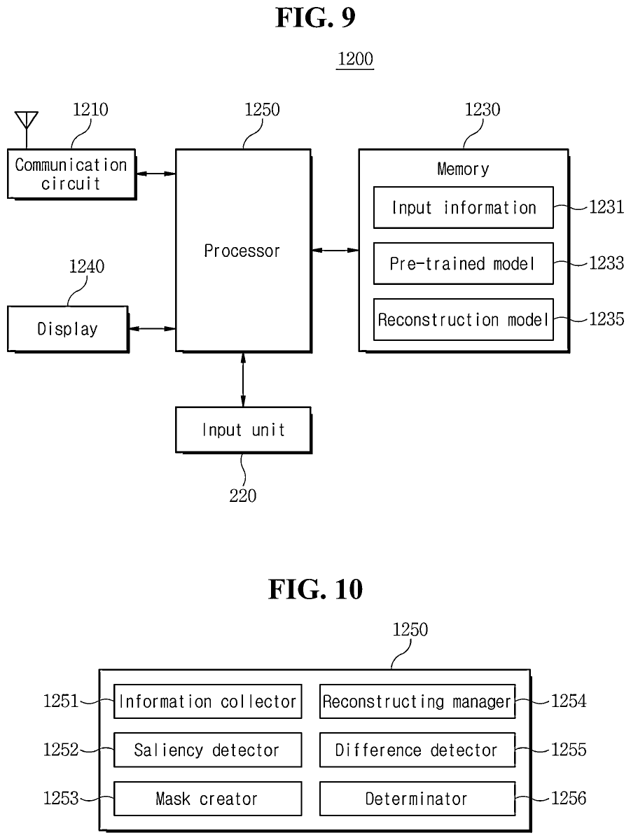

FIG. 9 is a diagram illustrating a second electronic device according to the second embodiment of the present disclosure. FIG. 10 is a diagram illustrating a processor of the second electronic device according to the second embodiment of the present disclosure. As mentioned above, if it is designed that the product anomaly detection function is to be processed in the first electronic device 1100, the second electronic device 1200 may be omitted. Therefore, in this case, the operations for detecting anomalies in the product 11 to be described below may be performed in the first electronic device 1100. Alternatively, the second electronic device 1200 may be integrated with the first electronic device 1100.

Referring to FIG. 9, the second electronic device 1200 may include a communication circuit 1210 (or a second communication circuit), an input unit 1220, a memory 1230 (or a second memory), a display 1240, and a processor 1250 (or a second processor).

The communication circuit 1210 may establish a communication channel with the first electronic device 1100. The communication circuit 1210 may receive information (e.g., images or audio information) about the product 11 from the first electronic device 1100 in response to a designated cycle or the occurrence of a predefined event.

The input unit 1220 is a component for an administrator's (or user's) input related to the operation of the second electronic device 1200. For example, the input unit 1220 may include various input mechanisms such as a keyboard, a mouse, a voice input device, a keypad, and a joystick. The input unit 1220 may create at least one of an input signal requesting the activation of the first electronic device 1100, an input signal requesting the time to collect information about the product 11, an input signal requesting the deactivation of the first electronic device 1100, and an input signal requesting the output of the anomaly or not of the product 11 in response to a user's manipulation, and transmit the created input signal to the processor 1250.

The memory 1230 may store at least one program or data necessary for the operation of the second electronic device 1200. For example, the memory 1230 may store input information 1231 about the product 11 received via the communication circuit 1210 and models based on an artificial neural network, such as a pre-trained model 1233 (or a pre-trained attention model or a saliency model, for example, DINO) and a reconstruction model 1235. The pre-trained model 1233 selects saliency regions that human vision focuses on first, and outputs the saliency region in the form of a map. For example, the pre-trained model 1233 may output a saliency map (or saliency map) for the input information 1231. The pre-trained model 1233 can reduce the computational load by supporting the use of algorithms on the saliency regions of the image that are most likely to contain objects, rather than applying computationally complex algorithms to the entire image. The pre-trained model 1233 may output an attention score for each region of information. The reconstruction model 1235 may include a model for reconstructing the original image.

The display 1240 may output at least one screen related to the operation of the second electronic device 1200. For example, the display 1240 may output a screen indicating a connection state with the first electronic device 1100, a screen indicating the reception of the input information 1231 provided by the first electronic device 1100, and a screen representing an anomaly detection on the product 11 based on analysis results of the received input information 1231.

The processor 1250 may control transmitting and processing signals necessary for the operation of the second electronic device 1200, storing or transmitting the processing results, or transmitting messages corresponding to the results. In this regard, referring to FIG. 10, the processor 1250 may include an information collector 1251, a saliency detector 1252, a mask creator 1253, a reconstructing manager 1254, a difference detector 1255, and a determinator 1256.

The information collector 1251 may receive information related to the product 11 from the first electronic device 1100. In this regard, the information collector 1251 may establish a communication channel with the first electronic device 1100 and receive images or audio information about the product 11 from the first electronic device 1100. The information collector 1251 may temporarily or semi-permanently store the received input information 1231 regarding the product 11 in the memory 1230. For example, the information collector 1251 may receive information about the type of product 11 from the product holder 13 or the input unit 1220, create a command requesting images or audio information depending on the type of the product 11, and provide the created command to the first electronic device 1100.

The saliency detector 1252 may generate a saliency map for the input information 1231. For example, the saliency detector 1252 may output a saliency map corresponding to an attention map of the input information 1231 by using the pre-trained model 1233 (e.g., DINO) stored in the memory 1230. The saliency map can give strong attention to information that needs to be focused on in given data, such as defect information. Even if the input information 1231 corresponds to a normal type, the saliency map may assign a relatively high attention score to a region (or location, pixel) that may be suspected of being a defect. The saliency detector 1252 may assign an attention score to each location (or region) in the saliency map.

The mask creator 1253 may create a mask based on a predefined reference score (e.g., an average attention score of the saliency map) for the saliency map outputted by the saliency detector 1252. For example, the mask creator 1253 may create the saliency mask for regions having values greater than or equal to the reference score (or values less than the reference score). Using the created saliency mask, the mask creator 1253 may perform mosaicking (or saliency mosaicking) on the anomaly-suspicious region where the attention score is relatively high. Specifically, in relation to performing saliency mosaicking, the mask creator 1253 may merge mosaic data outputted for the saliency region and original data for the non-saliency region.

The reconstructing manager 1254 may reconstruct the input information modified by applying the pre-trained model 1233 to the input information 1231 and selectively mosaicking regions where the attention score is greater than the threshold value. In this regard, the reconstructing manager 1254 may call the reconstruction model 1235 stored in the memory 230 and perform a reconstruction operation on the modified input information. The reconstructing manager 1254 may reconstruct the mosaicked regions with high attention scores (relatively high or higher than the reference score), thereby more accurately highlighting the anomaly regions. The reconstructing manager 1254 may provide the reconstructed output to the difference detector 1255.

When the difference detector 1255 receives the reconstructed output of the modified input information from the reconstructing manager 1254, it may calculate a difference with the input information 1231 stored in the memory 1230. For example, the difference detector 1255 may calculate a distance value between the input information 1231 and the output of the reconstructing manager 1254. The difference detector 1255 may transmit the distance value to the determinator 1256. The difference detector 1255 may determine the difference value as a reconstruction loss of the reconstruction model 1235 and use it to update the reconstruction model 1235. For example, the processor 1250 may perform learning of the reconstruction model 1235 using normal data until the reconstruction loss becomes less than a threshold value. The processor 1250 may terminate learning of the reconstruction model 1235 when the reconstruction loss less than a predefined threshold value occurs upon applying the reconstruction model 1235 of the input information 1231 corresponding to normal data, and the reconstruction model 1235 may be stored in the memory 1230. The reconstruction model 1235 may have the reconstruction loss less than a predefined threshold value for normal data and may be composed of an artificial neural network including at least one layer and a plurality of operation nodes. However, the reconstruction model according to the present disclosure is not limited to a specific type or form and may include a model capable of performing calculations based on hardware resources possessed by an edge computing device. For example, the edge computing device may correspond to a device including hardware resources enough to generate modified input information by performing a saliency mosaic on the input information 1231, apply the reconstruction model 1235 to the generated modified input information to obtain an output, and then detect anomalies based on normal data by comparing the obtained output and the input information 1231.

The determinator 1256 may receive the difference value between the input information 1231 and the output of the reconstruction model 1235 from the difference detector 1255. The determinator 1256 may store in advance a setting value for anomaly detection. Additionally or alternatively, the determinator 1256 may output a screen interface for adjusting a setting value for anomaly detection on the display 1240. The determinator 1256 may determine a value inputted through the input unit 1220 as a setting value for anomaly detection. If the difference value is greater than the setting value, the determinator 1256 may determine that the product 11 corresponding to the current input information 1231 is abnormal. If the difference value is less than or equal to the setting value, the determinator 1256 may determine that the product 11 corresponding to the current input information 1231 is normal. The determinator 1256 may output a result of determining whether the product 11 is normal or abnormal through the display 1240. Additionally or alternatively, the determinator 1256 may provide a normal or abnormal result of the product 11 to the terminal of the manager who monitors or manages the product 11.

As described hereinbefore, the second electronic device 1200 of the present disclosure performs a mosaic operation on the saliency regions, generates an output by reconstructing the mosaicked region to the original input form, and then determines the anomaly in the input information 1231 through the difference between the input and the output. In this process, the model for anomaly detection based on unsupervised learning is used, so it is possible to enhance the anomaly detection performance while maintaining the size and complexity of the artificial neural network at the same level.

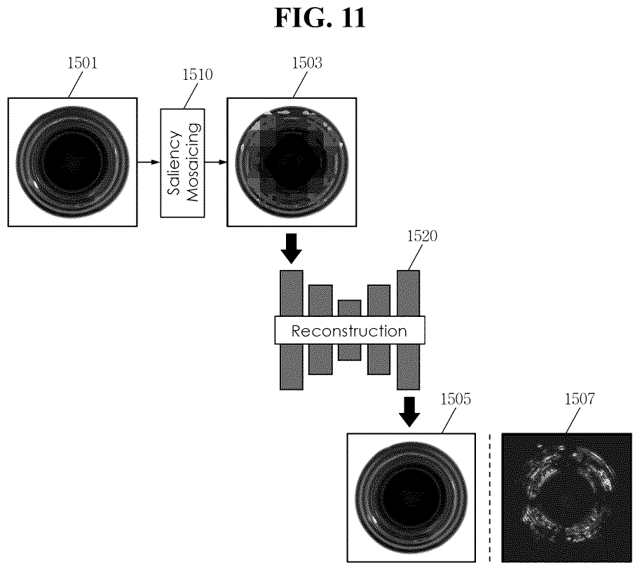

FIG. 11 is a diagram illustrating a process related to a learning strategy of an anomaly detection model according to the second embodiment of the present disclosure. Hereinafter, a case where the second electronic device 1200 performs learning of a model related to anomaly detection will be described as an example. However, the present disclosure is not limited to this example, and the first electronic device 1100 may perform learning of a model for anomaly detection.

Referring to FIG. 11, the processor 1250 (or the controller 1150) of the second electronic device 1200 (or the first electronic device 1100) may acquire input information 1501. The input information 1501 may include at least one of an image taken of the product 11 or audio information generated from the product 11. In an example, the input information 1501 may include a captured image of a glass bottle product. For example, the input information 1501 may be information classified as normal data. Alternatively, the input information 1501 may be obtained from a data set classified as normal data.

When the input information 1501 is acquired, the processor 1250 of the second electronic device 1200 may apply a pre-trained model to the input information 1501 and performs a mosaic operation 1510, thereby acquiring input information 1503 with saliency regions mosaicked. For example, the input information 1503 with saliency regions mosaicked may include information about the mosaic operation for saliency regions in the input information 1501.

The processor 1250 of the second electronic device 1200 may reconstruct the input information 1503 with saliency regions mosaicked by using the reconstruction model 1520. The processor 1250 of the second electronic device 1200 may calculate a difference value 1507 between the reconstructed output 1505 and the input information 1501. The difference value 1507 may be a reconstruction loss of the reconstruction model 1520 and may be used to update the reconstruction model 1520. For example, normal data may be provided as the input information 1501, and at least some of various parameters of the reconstruction model 1520 may be adjusted so that the difference value 1507 corresponding to reconstruction loss becomes less than a predetermined threshold value. When the number of times the reconstruction loss is calculated to be less than the predetermined threshold value after the mosaic operation on a certain number of normal data is more than a specified number of times, the processor 1250 of the second electronic device 1200 may complete the learning of the reconstruction model 1520.

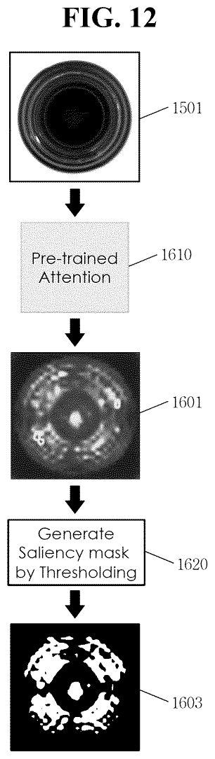

FIG. 12 is a diagram illustrating a method for selecting a saliency region in the learning strategy of the anomaly detection model according to the second embodiment of the present disclosure. FIG. 12 shows an example of a saliency mask generation process used for learning of a model for anomaly detection. Hereinafter, a case where the second electronic device 1200 performs the saliency region selecting method will be described as an example. However, the present disclosure is not limited to this example, and the first electronic device 1100 may perform the saliency region selecting method.

Referring to FIGS. 11 and 12, the processor 1250 (or the controller 1150) of the second electronic device 1200 (or the first electronic device 1100) may acquire input information 1501. The input information 1501 may include at least one of an image taken of the product 11 or audio information generated from the product 11. In an example, the input information 1501 may include a captured image of a glass bottle product.

When input information 1501 is acquired, the processor 1150 of the second electronic device 1200 may apply a pre-trained model 1610 to the acquired input information 1501. The pre-trained model 1610 may use, for example, DINO as a pre-trained attention model. The processor 1250 of the second electronic device 1200 may acquire a saliency map 1601 by applying the input information 1501 to the pre-trained model 1610. The saliency map 1601 gives strong attention to defect information and, even if the input data corresponds to a normal type, it may give relatively high attention to regions that may be suspected of being defects. By applying the input information 1501 to the pre-trained model 1610, the processor 1250 may acquire the saliency map 1601 containing regions for which attention scores are assigned.

The processor 1250 of the second electronic device 1200 may generate a saliency mask 1603 in the saliency map 1601 through a saliency mask generation process 1620. In relation to the saliency mask generation process 1620, the processor 1250 may identify a predetermined threshold value (or reference value) and, based on the identified threshold value, generate the saliency mask 1603 corresponding to the saliency map 1601. For example, the processor 1250 may calculate an average value for the attention scores of the saliency map 1601 and use the calculated average value as a threshold value. Alternatively, the processor 1250 may select the middle value between the maximum and minimum values among the attention scores of the saliency map 1601 as the threshold value, or select the average value of the remaining values excluding the maximum and minimum values as the threshold value.

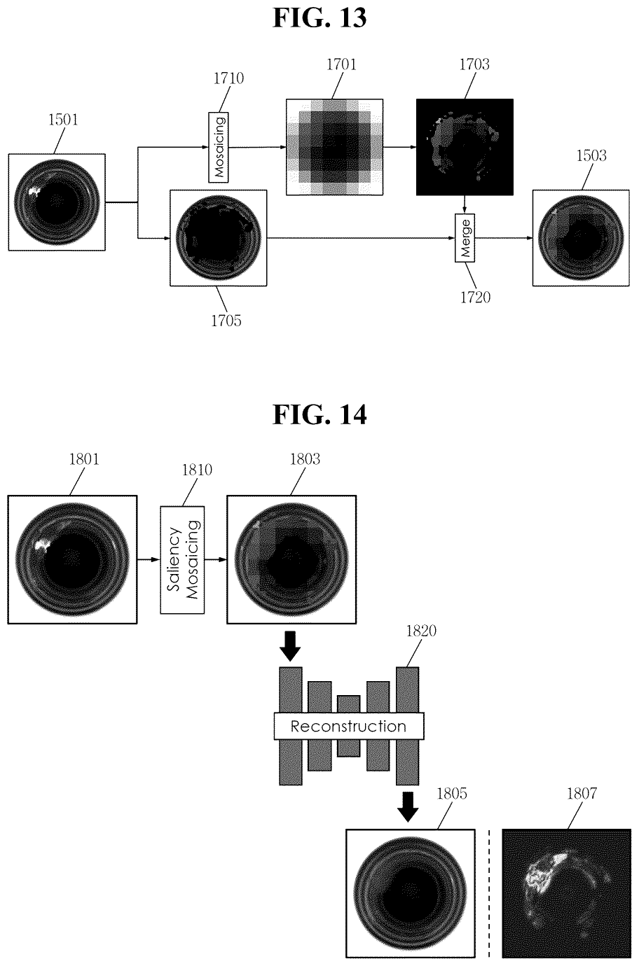

FIG. 13 is a diagram illustrating a method for calculating input information with saliency region mosaicked in the learning strategy of the anomaly detection model according to the second embodiment of the present disclosure. Hereinafter, a case where the second electronic device 1200 performs the method for calculating input information with saliency region mosaicked will be described as an example. However, the present disclosure is not limited to this example, and the first electronic device 1100 may perform the method for calculating input information with saliency region mosaicked.

Referring to FIGS. 11 to 13, the processor 1250 (or the controller 1150) of the second electronic device 1200 (or the first electronic device 1100) may acquire input information 1501.

The processor 1250 of the second electronic device 1200 may acquire mosaicked input information 1701 by performing mosaic processing 1710 on the input information 1501. The processor 1250 may acquire masked and mosaicked input information 1703 by applying the saliency mask 1603 previously described in FIG. 12 to the mosaicked input information 1701. For example, the processor 1250 may perform convolution between the saliency mask 1603 and the mosaicked input information 1701 and thus calculate a first intermediate output 1703 (e.g., mosaic data).

On the other hand, the processor 1250 of the second electronic device 1200 may calculate a second intermediate output 1705 by performing convolution between the input information 1501 and the inverse value of the saliency mask 1603. The first intermediate output 1703 may correspond to mosaic data calculated for a saliency region by performing a mosaic operation (or saliency mosaicking) on an anomaly-suspicious region where the attention score is relatively high (or higher than the threshold value). The second intermediate output 1705 may correspond to original data for a non-saliency region.

The processor 1250 of the second electronic device 1200 may merge (1720) the first intermediate output 1703, in which the saliency regions are mosaicked, and the second intermediate output 1705, and thereby generate input information 1503 with saliency region mosaicked (or saliency mosaic data, saliency mosaicking data). The mosaicked input information 1503 may correspond to the mosaicked input information 1503 previously described in FIG. 11.

FIG. 14 is a diagram illustrating a product anomaly detection process according to the second embodiment of the present disclosure. Hereinafter, a case where the second electronic device 1200 performs the anomaly detection process will be described as an example. However, the present disclosure is not limited to this example, and the first electronic device 1100 may perform the anomaly detection process.

Referring to FIGS. 11 to 14, the processor 1250 (or the controller 1150) of the second electronic device 1200 (or the first electronic device 1100) may acquire new input information 1801. The new input information 1801 may include at least one of an image taken of the product 11 or audio information generated from the product 11. In an example, the new input information 1801 may include a captured image of a glass bottle product.

When the new input information 1801 is acquired, the processor 1250 of the second electronic device 1200 may apply a pre-trained model to the new input information 1801 and perform a mosaic operation 1810, thereby acquiring new input information 1803 in which saliency regions are mosaicked. For example, the new input information 1803 with saliency regions mosaicked may include information about the mosaic operation for saliency regions (or feature regions or defective regions) in the new input information 1801.

The processor 1250 of the second electronic device 1200 may calculate a new reconstructed output 1805 by applying the new input information 1803 with saliency regions mosaicked to the reconstruction model 1820 with learning completed. The processor 1250 of the second electronic device 1200 may calculate a difference value 1807 between the reconstructed and learning-completed new output 1805 and the new input information 1801. The processor 1250 may compare the difference value 1807 with a predetermined threshold value (or reference value). If the difference value 1807 does not exceed the threshold value, the processor 1250 may determine the new input information 1801 as normal, and if the difference value 1507 exceeds the threshold value, the processor 1250 may determine the new input information 1801 as abnormal.

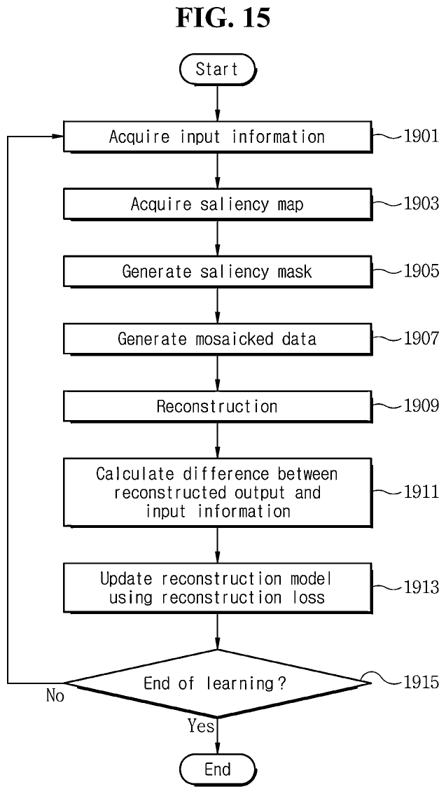

FIG. 15 is a diagram illustrating a method for learning a product anomaly detection model performed by the second electronic device according to the second embodiment of the present disclosure. The model learning method described below may be performed by the first electronic device 100.

Referring to FIGS. 9 and 15, the processor 1250 of the second electronic device 1200 may acquire the input information 1231 in step 1901. In this regard, the processor 1250 may establish a communication channel with the first electronic device 1100 and request the first electronic device 1100 to provide the input information 1231 about the product 11. Then, the first electronic device 1100 may collect the input information 1231 about the product 11 in response to predetermined schedule information or commands provided by the second electronic device 1200 and provide it to the second electronic device 1200. Alternatively, the processor 1250 may connect to a server that provides a data set including normal data, and acquire data for model training from the server. Alternatively, the processor 1250 may collect a certain number or more of the input information 1231 classified as normal data from the first electronic device 1100.

In step 1903, the processor 1250 may acquire a saliency map based on the input information 1231. In this regard, the processor 1250 may calculate the saliency map by applying the acquired input information 1231 to the pre-trained model 1233 stored in the memory 1230. The saliency map may include, for example, a map that emphasizes defect information (or a defective region in an image) over other regions. The saliency map may include an attention score assigned to each region (or each pixel, or each pixel group of a certain size).

In step 1905, the processor 1250 may generate a saliency mask using the saliency map. For example, the processor 1250 may apply a predefined reference value (e.g., the average value of the attention scores of the entire saliency map) to the attention scores assigned to each region, select certain regions, and generate the saliency mask. For example, the processor 1250 may generate the saliency mask by selecting, from the saliency map, only regions having the predefined reference value or more.

In step 1907, the processor 1250 may perform partial mosaics on the input information 1231. For example, as previously described in FIG. 13, the processor 1250 may apply the saliency mask to the input information 1231 to output information with saliency regions applied and information with no saliency regions applied, apply the mosaic to the information with saliency regions applied, and merge together the information with saliency regions applied and the information with no saliency regions applied. As a result, mosaicked data may be generated.

In step 1909, the processor 1250 may perform reconstruction of the mosaicked data. In this regard, the processor 1250 may generate a reconstructed output by applying the mosaicked data to the reconstruction model 1235, which is being learned, stored in the memory 1230.

In step 1911, the processor 1250 may calculate a difference between the reconstructed output and the input information. For example, the processor 1250 may calculate a distance value for the difference between the reconstructed output and input information as a reconstruction loss.

In step 1913, the processor 1250 may update the reconstruction model 1235 using the reconstruction loss. In step 1915, the processor 1250 may check whether conditions related to the end of learning for the reconstruction model 1235 are satisfied. For example, processor 1250 may check whether the reconstruction loss is less than a predefined threshold value. If the reconstruction loss is less than the predefined threshold value, the processor 1250 may determine that learning of the reconstruction model 1235 has ended. If the reconstruction loss is greater than or equal to the predefined threshold value, the processor 1250 may return to step 901 and re-perform the subsequent operations.

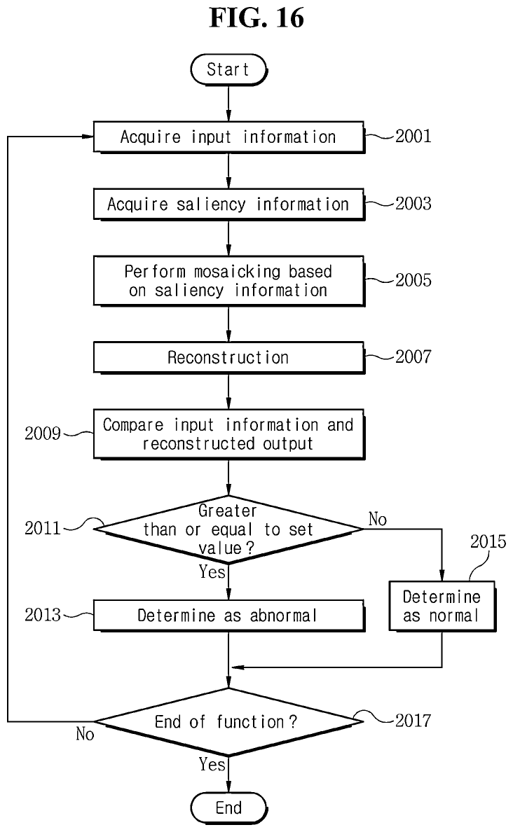

FIG. 16 is a diagram illustrating a method for a product anomaly detection performed by the second electronic device according to the second embodiment of the present disclosure. The product anomaly detection method described below may be performed by the first electronic device 100.

Referring to FIG. 16, in step 2001, the processor 1250 of the second electronic device 1200 may acquire the input information 1231 along with a message requesting the anomaly detection for the product 11. The input information 1231 may include, for example, input information (e.g., captured image information or audio information) obtained from the product 11 mounted on the product holder 13.

In step 2003, the processor 1250 may acquire saliency information for the acquired input information 1231. For example, the processor 1250 may acquire saliency information (e.g., a saliency map for salient regions) for the input information 1231 using the pre-trained model 1233 stored in the memory 1230.

In step 2005, the processor 1250 may perform mosaicking on the input information 1231 using the acquired saliency information. The processor 1250 may mosaic the salient regions of the input information 1231 to generate mosaicked input information.

In step 2007, the processor 1250 may perform reconstruction on the mosaicked input information. In this regard, the processor 1250 may call the reconstruction model 1235 with learning completed from the memory 1230 and apply the mosaicked input information to the called reconstruction model 1235 to produce a reconstructed output.

In step 2009, the processor 1250 may compare the input information 1231 and the reconstructed output. In this process, the processor 1250 may calculate a distance value between the input information 1231 and the reconstructed output.

In step 2011, the processor 1250 may check whether the calculated distance value is greater than or equal to a predefined setting value. The predefined setting value is a value to be used for determining anomalies and may be set statistically or empirically. Alternatively, a certain number of normal data may be entered as input information 1231, and the average value of distance values calculated by comparison with the reconstructed output may be determined as the setting value. Alternatively, the processor 1250 may output a screen interface for inputting the setting value and determine the setting value according to an administrator's input.

If the comparison value (or the distance value between the input information 1231 and the reconstructed output) is greater than or equal to the setting value, the processor 1250 may determine the input information 1231 as an abnormal product in step 2013. If the product 11 is determined to be abnormal, the processor 1250 may notify about the abnormality of the product 11. For example, the processor 1250 may create an abnormality notification message, and provide it to the electronic device that provided the input information 1231, output it through the display 1240 of the second electronic device 1200, or provide it to a designated administrator's terminal.

If the comparison value is less than the setting value, the processor 1250 may determine the input information 1231 as a normal product in step 2015. The processor 250 may output a result of this determination.

In step 2017, the processor 1250 may terminate the anomaly detection function when an event related to the termination of the anomaly detection function for the product 11 occurs (e.g., when the input information 1231 for anomaly detection is not received within a specified time, or when an administrator's termination input occurs). If no termination event occurs or new input information is received, the processor 1250 may return to step 2001 and re-perform the subsequent operations.

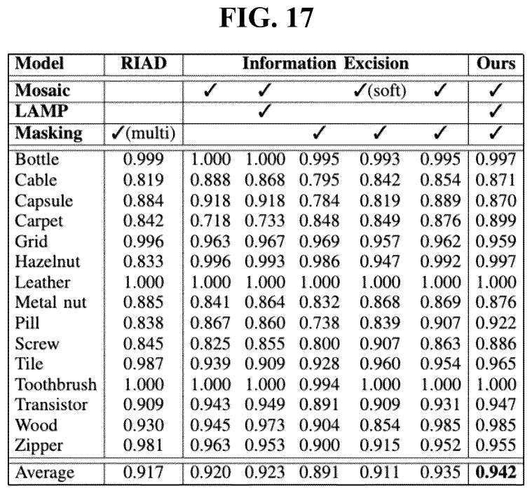

FIG. 17 is a diagram illustrating measurement results for anomaly detection performance for the anomaly detection data set MVTec AD.

Referring to FIG. 17, in a list of numbers, the first column on the left shows the performance of the RIAD method proposed by Vitjan Zavrtanik et al. This method uses multiple random masking technique to modify the input image. Multiple random masking has the problem of low output consistency because the output changes at every moment even if the same input is given. Moreover, the RAID method cannot accurately specify the masking region, so there is a limit to improving computation speed in that inference must be performed for multiple masks and each masked image. Meanwhile, the proposed method (Ours) of the present disclosure corresponds to the seventh column, and the partially applied results are shown in the second, third and sixth columns. The second column shows the result of uniformly mosaicking the entire input information, and the third column shows the result of adding LAMP loss to the training process after uniformly mosaicking the entire input information. The fourth column shows the results of saliency region masking (cut out) based on the pre-trained attention model, and the fifth column shows the results of smoothing the information corresponding to the saliency region based on the pre-trained attention model. The sixth column shows the results of mosaicking the information corresponding to the saliency region based on the pre-trained attention model. The seventh column shows the results of mosaicking the information corresponding to the saliency region based on the pre-trained attention model and then additionally introducing LAMP loss in the training process. It can be seen that the proposed method of the present disclosure can achieve performance improvement even in the case of partial application, and the performance improvement is greater when the entire process is applied. Additionally, it can be seen that the proposed method of the present disclosure produces meaningful results as a method of maximizing performance without changing the size or complexity of the artificial neural network, that is, while using the same artificial neural network.

What has been described above can be said to be a method of modifying input data to improve anomaly detection performance while maintaining the size and complexity of the artificial neural network at the same level in the unsupervised learning-based anomaly detection environment of the present disclosure. The input data modifying method includes a method of producing a saliency map, and based on the saliency map, a saliency mask is generated to select a relatively suspected defective region in the input data. The information on the suspected defective region can be additionally modified the generated saliency mask. In the present disclosure, the processor 1250 may selectively use one or more of mosaicking, smoothing, and cut out as a method of additionally modifying information on the suspected defective region. The present disclosure makes it possible to avoid a situation where reconstruction errors of unintended defect information are reduced based on input data modification. For example, in the present disclosure, an unsupervised learning-based artificial neural network receives defect information in input data and accurately reconstructs unintended defect information, thereby reducing reconstruction errors and avoiding situations in which errors occur in anomaly detection or defect determination. Meanwhile, when the input data is an image, the present disclosure prevents all pixel information from being inputted to the artificial neural network. Additionally, when the input material is audio, the present disclosure prevents all amplitude information from being inputted to the artificial neural network. As such, the present disclosure provides a method of reducing the amount of information that can be obtained by an artificial neural network by modifying input data according to rules specified by the user.

While the specification contains many specific implementation details, these should not be construed as limitations on the scope of the present disclosure or of what may be claimed, but rather as descriptions of features that may be specific to particular embodiments of particular disclosure.

Also, although the present specifications describe that operations are performed in a predetermined order with reference to a drawing, it should not be construed that the operations are required to be performed sequentially or in the predetermined order, which is illustrated to obtain a preferable result, or that all of the illustrated operations are required to be performed. In some cases, multi-tasking and parallel processing may be advantageous. Also, it should not be construed that the division of various system components are required in all types of implementation. It should be understood that the described program components and systems are generally integrated as a single software product or packaged into a multiple-software product.

This description shows the best mode of the present invention and provides examples to illustrate the present invention and to enable a person skilled in the art to make and use the present invention. The present invention is not limited by the specific terms used herein. Based on the above-described embodiments, one of ordinary skill in the art can modify, alter, or change the embodiments without departing from the scope of the present invention.

Accordingly, the scope of the present invention should not be limited by the described embodiments and should be defined by the appended claims.

What is claimed is:

1. An electronic device comprising:
a memory storing normal data; and
a processor functionally connected to the memory,
the processor configured to:
acquire the normal data from the memory,
select a first specific position of the normal data as an initial position according to setting, select first data being at the initial position, and exchange the first data with second data being at a second specific position corresponding to a movement direction and movement distance value set based on the first specific position, wherein the exchange is repeated a predetermined number of times, and
store data after the exchange between the first data and the second data in the normal data is repeatedly performed the predetermined number of times, in the memory as abnormal data for training a machine learning model.

2. The electronic device of claim 1, wherein the normal data is image data, and the processor is configured to select at least one pixel data disposed at the first specific position of the image data as the first data of the initial position, and to select one of eight adjacent pixel directions based on the first specific position as the movement direction.

3. The electronic device of claim 2, wherein the processor is configured to select at least one pixel direction among the eight pixel directions according to a user input, and to determine a randomly selected movement direction among the at least one selected pixel direction as the movement direction.

4. The electronic device of claim 1, wherein the processor is configured to select a randomly selected constant value within a certain constant range as the movement distance value, and to determine a position spaced apart from the first specific position by the selected movement distance value as the second specific position.

5. The electronic device of claim 4, wherein the processor is configured to adjust the constant range according to a user input.

6. The electronic device of claim 1, wherein the processor is configured to select a randomly selected constant value within a certain constant range as the movement distance value, and to calculate a new movement distance value every time during the predetermined number of times.

7. The electronic device of claim 1, wherein the processor is configured to define a plurality of pixel data arranged at the first specific position as a kernel, and to perform the exchange on a per kernel basis.

8. A learning data generation method performed by a processor of an electronic device, the method comprising:
acquiring normal data from a memory;
selecting a first specific position of the normal data as an initial position according to setting, selecting first data being at the initial position, and exchanging the first data with second data being at a second specific position corresponding to a movement direction and movement distance value set based on the first specific position, wherein the exchanging is repeated a predetermined number of times; and
storing data after the exchanging between the first data and the second data in the normal data is repeatedly performed the predetermined number of times, in the memory as abnormal data for training a machine learning model.

9. The method of claim 8, wherein the normal data is image data, at least one pixel data disposed at the first specific position of the image data is selected as the first data of the initial position, and one of eight adjacent pixel directions based on the first specific position is selected as the movement direction.

10. The method of claim 9, wherein at least one pixel direction among the eight pixel directions is selected according to a user input, and a randomly selected movement direction among the at least one selected pixel direction is determined as the movement direction.

11. The method of claim 8, wherein a randomly selected constant value within a certain constant range is selected as the movement distance value, and a position spaced apart from the first specific position by the selected movement distance value is selected as the second specific position.

12. The method of claim 11, wherein the constant range is adjusted according to a user input.

13. The method of claim 8, wherein a randomly selected constant value within a certain constant range is selected as the movement distance value, and a new movement distance value is calculated every time during the predetermined number of times.

14. The method of claim 8, wherein a plurality of pixel data arranged at the first specific position is defined as a kernel, and the exchanging is performed on a per kernel basis.

15. An electronic device comprising:
a communication circuit receiving input information about a product;
a memory storing the input information; and
a processor functionally connected to the communication circuit and the memory, the processor configured to:
for learning of a reconstruction model for anomaly detection in the product, select salient regions for the input information,
generate input information with salient regions mosaicked by performing a mosaic operation on the selected salient regions,
generate a reconstructed output by applying the input information with salient regions mosaicked to the reconstruction model, and
update the reconstruction model based on a difference value between the input information and the reconstructed output.

16. The electronic device of claim 15, wherein the processor is configured to:
produce a saliency map by applying a pre-trained model to the input information, and
produce a saliency mask based on the saliency map.

17. The electronic device of claim 16, wherein the processor is configured to:
select the salient regions of the input information by mosaicking the input information and then performing convolution with the saliency mask,
produce mosaic data by performing a mosaic operation on the selected salient regions,
produce original data for non-salient regions of the input information by applying the inverse value of the salient mask to the input information, and
generate the input information with salient regions mosaicked by merging the mosaic data and the original data.

18. The electronic device of claim 15, wherein the processor is configured to:
update the reconstruction model so that the difference value between the input information and the reconstructed output is less than a predetermined threshold value, and
complete the learning of the reconstruction model when the difference value is less than the predetermined threshold value.

19. The electronic device of claim 18, wherein the processor is configured to:
upon acquiring new input information about a new product, produce new input information with salient regions mosaicked by applying the new input information to a pre-trained model,
produce a new reconstructed output by applying the new input information with salient regions mosaicked to the learning-completed reconstruction model,
when a difference value between the new input information and the new reconstructed output is less than a predetermined threshold value, determine that a product corresponding to the new input information is normal, and
when the difference value between the new input information and the new reconstructed output is greater than or equal to a predetermined threshold value, determine that the product corresponding to the new input information is abnormal.

20. The electronic device of claim 19, wherein the difference value includes a distance value between the new input information and the new reconstructed output.

21. A product anomaly detection method based on unsupervised learning, performed by a processor of an electronic device, the method comprising:
for learning of a reconstruction model for anomaly detection in a product, selecting salient regions for an input information;
generating input information with salient regions mosaicked by performing a mosaic operation on the selected salient regions;
generating a reconstructed output by applying the input information with salient regions mosaicked to the reconstruction model; and
updating the reconstruction model based on a difference value between the input information and the reconstructed output.

22. The method of claim 21, further comprising:
producing a saliency map by applying a pre-trained model to the input information; and
producing a saliency mask based on the saliency map.

23. The method of claim 22, wherein selecting the salient regions includes:
selecting the salient regions of the input information by mosaicking the input information and then performing convolution with the saliency mask, and
wherein generating the input information with salient regions mosaicked includes:
producing mosaic data by performing a mosaic operation on the selected salient regions;
producing original data for non-salient regions of the input information by applying the inverse value of the salient mask to the input information; and
generating the input information with salient regions mosaicked by merging the mosaic data and the original data.

24. The method of claim 21, wherein updating the reconstruction model includes:
updating the reconstruction model so that the difference value between the input information and the reconstructed output is less than a predetermined threshold value; and
completing the learning of the reconstruction model when the difference value is less than the predetermined threshold value.

25. The method of claim 24, further comprising:
acquiring new input information about a new product;
producing new input information with salient regions mosaicked by applying the new input information to a pre-trained model;
producing a new reconstructed output by applying the new input information with salient regions mosaicked to the learning-completed reconstruction model;
when a difference value between the new input information and the new reconstructed output is less than a predetermined threshold value, determining that a product corresponding to the new input information is normal; and
when the difference value between the new input information and the new reconstructed output is greater than or equal to a predetermined threshold value, determining that the product corresponding to the new input information is abnormal.

26. The method of claim 25, wherein the difference value includes a distance value between the new input information and the new reconstructed output.
